(19) United States
(12) Patent Application Publication
(10) Pub. No.: US 2005/0130024 A1
(43) Pub. Date: Jun. 16, 2005

(54) Proton conductive composition and proton conductive membrane

(75) Inventors: Toshihiro Otsuki, Tokyo (JP); Junji Kawai, Tokyo (JP); Mayumi Kakuta, Tokyo (JP); Nagayuki Kanaoka, Wako-shi (JP); Yoichi Asano, Wako-shi (JP); Ryoichiro Takahashi, Wako-shi (JP)

Correspondence Address: ARENT FOX KINTNER PLOTKIN & KAHN, PLLC, Suite 400, 1050 Connecticut Avenue, N.W., Washington, DC, 20036-5339, US

(73) Assignees: JSR CORPORATION; HONDA MOTOR CO., LTD.

(21) Appl. No.: 11/007,329

(22) Filed: Dec. 9, 2004

(30) Foreign Application Priority Data
Dec. 10, 2003 (JP) 2003-411754

(51) Int. Cl. H01C 1/00

(52) U.S. Cl. 429/42; 252/500

(57) ABSTRACT

The invention provides a proton conductive membrane which, even when reduced in thickness, does not allow penetration of an electrode to prevent a short circuit between electrodes and which permits sufficient generating performance. A proton conductive composition capable of forming the membrane is also provided. The proton conductive composition includes a nonconductive filler and a polyarylene having a sulfonic group. The proton conductive membrane, comprising the composition, contains the nonconductive filler in an amount of 3 to 50% by volume, and the nonconductive filler particles have diameters ranging from 3 to 90% the thickness of the membrane.

### FIELD OF THE INVENTION

The present invention relates to a proton conductive membrane for use as a solid polymer electrolyte membrane in a solid polymer fuel cell, and to a composition for the membrane.

### BACKGROUND OF THE INVENTION

A fuel cell essentially consists of two catalyst electrodes and a solid electrolyte membrane sandwiched between the electrodes. Hydrogen, which is a fuel, is ionized at one of the electrodes, and the hydrogen ions diffuse through the solid electrolyte membrane and combine with oxygen at the other electrode. When the two electrodes are connected through an external circuit, electric-current flows and electric power is supplied to the external circuit. To achieve higher output characteristics of fuel cells, various studies are carried out for enhanced electrode catalyst activity and gas diffusion electrode properties, and for reduction of resistance loss. Typical resistance losses are conductor resistance loss, contact resistance loss and membrane resistance loss.

The resistance of a solid electrolyte membrane tends to decrease as the membrane contains higher proportions of water, has higher ion exchange capacity, and has smaller thickness. The water content in the membrane depends on the humidity of the gas supplied, and the membrane's ion exchange capacity is determined by the membrane properties. Therefore, studies are mainly focused on reduction of membrane thickness because of relative easiness of lowering the membrane resistance loss. However, reduction of the membrane thickness is accompanied by lowered membrane strength. Accordingly, the electrodes will penetrate the membrane during production of a membrane-electrode assembly or during operation of a fuel cell, resulting in a short circuit between the electrodes.

JP-B-H05(1993)-75835 proposes an ion exchange membrane including a porous polytetrafluoroethylene film reinforced by impregnation of an ion exchange perfluoro resin. This membrane, although improved in dimensional stability and mechanical strength, is not still satisfactory.

### OBJECTS OF THE INVENTION

It is an object of the invention to provide a proton conductive membrane which, even when reduced in thickness, does not allow penetration of an electrode to prevent a short circuit between electrodes and which permits sufficient generating performance. It is another object of the invention to provide a proton conductive composition capable of forming the membrane.

### DISCLOSURE OF THE INVENTION

The present inventors carried out earnest studies in view of the problems in the background art. As a result, it has been found that incorporation of nonconductive filler particles within a polyarylene having a sulfonic group leads to a proton conductive membrane which, even when reduced in thickness, does not allow penetration of an electrode to prevent a short circuit between electrodes and which permits sufficient generating performance.

The present invention achieves the aforesaid objects by providing the following proton conductive compositions and proton conductive membranes:

(1) A proton conductive composition comprising nonconductive filler particles and a polyarylene having a sulfonic group.

(2) The proton conductive composition as described in (1), wherein the polyarylene having a sulfonic group includes a structural unit represented by the following formula (A) and a structural unit represented by the following formula (B): 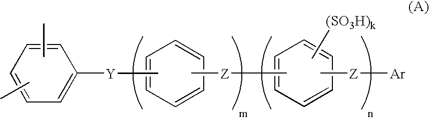
wherein Y is a divalent electron-withdrawing group; Z is a divalent electron-donating group or a direct bond; Ar is an aromatic group with a substituent —SO₃H; m is an integer of 0 to 10; n is an integer of 0 to 10; and k is an integer of 1 to 4; 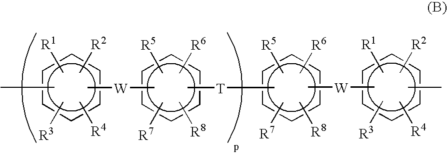
wherein R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group; W is a divalent electron-withdrawing group or a single bond; T is a divalent organic group or a single bond; and p is 0 or a positive integer.

(3) A proton conductive membrane comprising the proton conductive composition as described in (1) or (2).

(4) The proton conductive membrane as described in (3), wherein the nonconductive filler particles are contained in an amount of 3 to 50% by volume of the proton conductive membrane and have particle diameters ranging from 3 to 90% the thickness of the proton conductive membrane.

### PREFERRED EMBODIMENTS OF THE INVENTION

Hereinbelow, the proton conductive compositions containing nonconductive filler particles and a polyarylene having a sulfonic group, and the proton conductive membranes of the invention will be described in detail.

(Nonconductive Filler)

The nonconductive filler for use in the present invention is particles that have a function of maintaining a certain thickness of the proton conductive membrane even when the membrane is softened. The filler shall be nonconductive to prevent a short circuit between the electrodes. Examples of the nonconductive fillers having such functions include oxides such as silica, titania and alumina; complex oxides such as perovskite and spinel; glass such as quartz and silicate glass; carbides such as titanium carbide and silicon carbide; nitrides such as boron nitride and silicon nitride; and plastics such as nylons and fluororesins including polytetrafluoroethylene. These may be used either individually or in combination of two or more kinds.

The material of the nonconductive filler is preferably such that it shows corrosion resistance under strongly acidic conditions as in the proton conductive membranes, and is hydrophilic. The shape of the filler particles is not particularly limited, but is preferably spherical because a uniform shape may be easily obtained.

The size of the nonconductive filler particles may vary depending on the thickness of the proton conductive membrane. Desirably, the particles have diameters ranging from 3 to 90%, and preferably from 20 to 70% the thickness of the proton conductive membrane. When the size of the nonconductive filler particles is below the above range, prevention of a short circuit between the electrodes may not be ensured. If the size is greater than the above range, the proton conductive membrane becomes less uniform and the nonconductive filler particles are likely to protrude from the membrane to cause troubles. Specifically, the nonconductive filler particles desirably have particle diameters from 0.5 to 50 μm, and preferably from 1 to 30 μm.

(Polyarylene Having a Sulfonic Group)

The polyarylene having a sulfonic group for use in the present invention is preferably a polymer represented by the formula (C) given below. The polymer includes a structural unit of the following formula (A) and a structural unit of the following formula (B):

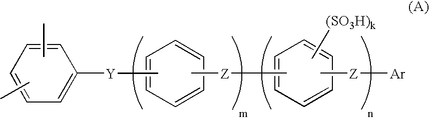

In the formula (A), Y is a divalent electron-withdrawing group such as —CO—, —SO₂—, —SO—, —CONH—, —COO—, —(CF₂)₁— (where 1 is an integer of 1 to 10) and —C(CF₃)₂—; and
Z is a direct bond or a divalent electron-donating group such as —(CH₂)—, —C(CH₃)₂—, —O—, —S—, —CH═CH—, —C≡C— and groups represented by:

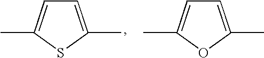

The electron-withdrawing group is defined as having a Hammett substituent constant of not less than 0.06 at the m-position and not less than 0.01 at the p-position of the phenyl group.

Ar denotes an aromatic group with a substituent —SO₃H. Exemplary aromatic groups include phenyl, naphthyl, anthryl and phenanthryl groups, with the phenyl and naphthyl groups being preferred.

In the formula (A), m is an integer of 0 to 10, preferably 0 to 2; n is an integer of 0 to 10, preferably 0 to 2; and k is an integer of 1 to 4.

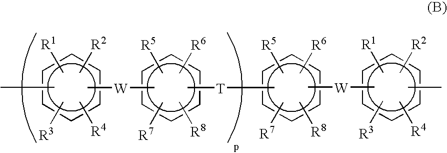

In the formula (B), R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group.

The alkyl groups include methyl, ethyl, propyl, butyl, amyl and hexyl groups, with the methyl and ethyl groups being preferred.

The fluorine-substituted alkyl groups include trifluoromethyl, perfluoroethyl, perfluoropropyl, perfluorobutyl, perfluoropentyl and perfluorohexyl groups, with the trifluoromethyl and perfluoroethyl groups being preferred.

The allyl groups include propenyl group.

The aryl groups include phenyl and pentafluorophenyl groups.

W is a divalent electron-withdrawing group or a single bond, T is a divalent organic group or a single bond, and p is 0 or a positive integer of generally up to 100 and is preferably from 10 to 80.

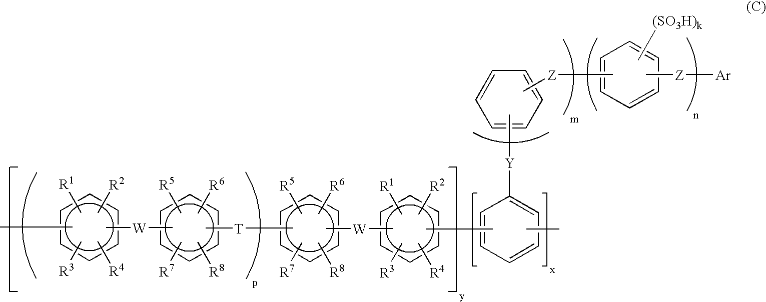

In the formula (C), W, T, Y, Z, Ar, m, n, k, p and R¹ to R⁸ are as described in the formulae (A) and (B), and x and y indicate a molar ratio such that x+y=100 mol %.

The polyarylene having a sulfonic group contains 0.5 to 100 mol %, preferably 10 to 99.999 mol % the structural unit of the formula (A), and 99.5 to 0 mol %, preferably 90 to 0.001 mol % the structural unit of the formula (B).

(Production of the Polyarylene Having a Sulfonic Group)

The polyarylene having a sulfonic group may be synthesized by copolymerizing a monomer which has a sulfonate group and is capable of forming the structural unit of the formula (A) with an oligomer capable of forming the structural unit of the formula (B) to produce a polyarylene having a sulfonate group, and subsequently hydrolyzing the polyarylene to convert the sulfonate group into the sulfonic group.

Alternatively, the polyarylene having a sulfonic group may be synthesized by sulfonating a polyarylene that includes the structural unit represented by the formula (A) except that it has no sulfonic or sulfonate groups and the structural unit represented by the formula (B).

The monomers capable of forming the structural unit of the formula (A) include sulfonates represented by the following formula (D) (hereinafter, the monomers (D)):

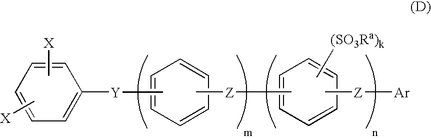

In the formula (D), X denotes a halogen atom other than fluorine (i.e., chlorine, bromine or iodine) or a —OSO₂G group (where G is an alkyl, fluorine-substituted alkyl or aryl group), and Y, Z, m, n and k are as described in the formula (A).

R^{a} denotes a hydrocarbon group of 1 to 20, and preferably 4 to 20 carbon atoms. Specific examples thereof include linear hydrocarbon groups, branched hydrocarbon groups, alicyclic hydrocarbon groups and 5-membered heterocyclic ring hydrocarbon groups, such as methyl, ethyl, n-propyl, iso-propyl, tert-butyl, iso-butyl, n-butyl, sec-butyl, neopentyl, cyclopentyl, hexyl, cyclohexyl, cyclopentylmethyl, cyclohexylmethyl, adamantyl, adamantanemethyl, 2-ethylhexyl, bicyclo[2.2.1]heptyl, bicyclo[2.2.1]heptylmethyl, tetrahydrofurfuryl, 2-methylbutyl, 3,3-dimethyl-2,4-dioxolanemethyl, cyclohexylmethyl, adamantylmethyl and bicyclo[2.2.1]heptylmethyl groups. Of these groups, the n-butyl, neopentyl, tetrahydrofurfuryl, cyclopentyl, cyclohexyl, cyclohexylmethyl, adamantylmethyl and bicyclo[2.2.1]heptylmethyl groups are preferred, and the neopentyl group is particularly preferable.

Ar denotes an aromatic group with a substituent —SO₃Rb. Exemplary aromatic groups include phenyl, naphthyl, anthryl and phenanthryl groups, with the phenyl and naphthyl groups being preferred.

The aromatic group is substituted with one or more substituents —SO₃R^{b}. When two or more substituents —SO₃R^{b} are present, they may be the same as or different from one another.

R^{b} denotes a hydrocarbon group of 1 to 20, and preferably 4 to 20 carbon atoms. Specific examples thereof include the above-described hydrocarbon groups having 1 to 20 carbon atoms. Of such groups, the n-butyl, neopentyl, tetrahydrofurfuryl, cyclopentyl, cyclohexyl, cyclohexylmethyl, adamantylmethyl and bicyclo[2.2.1]heptylmethyl groups are preferred, and the neopentyl group is particularly preferable.

Specific examples of the sulfonates represented by the formula (D) include compounds listed below:

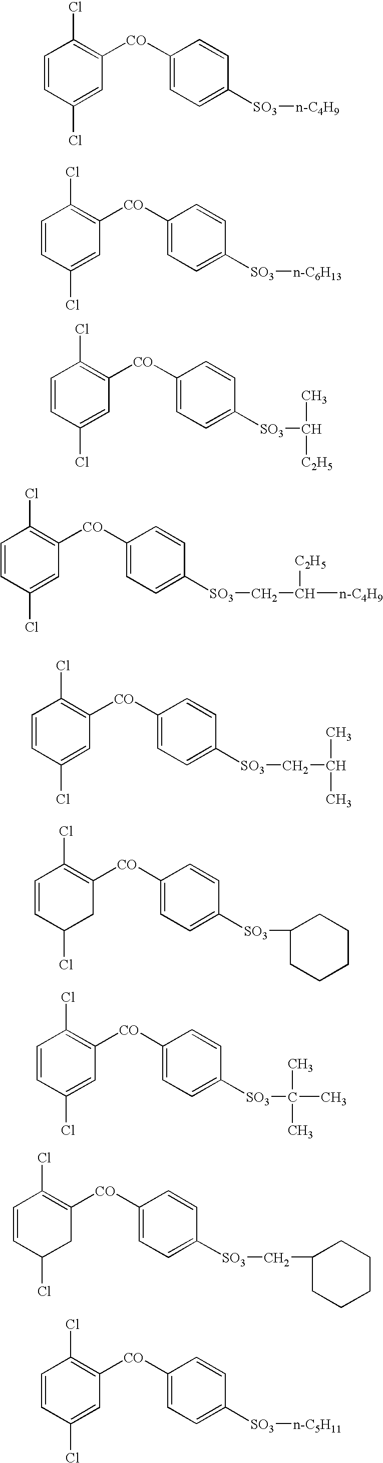

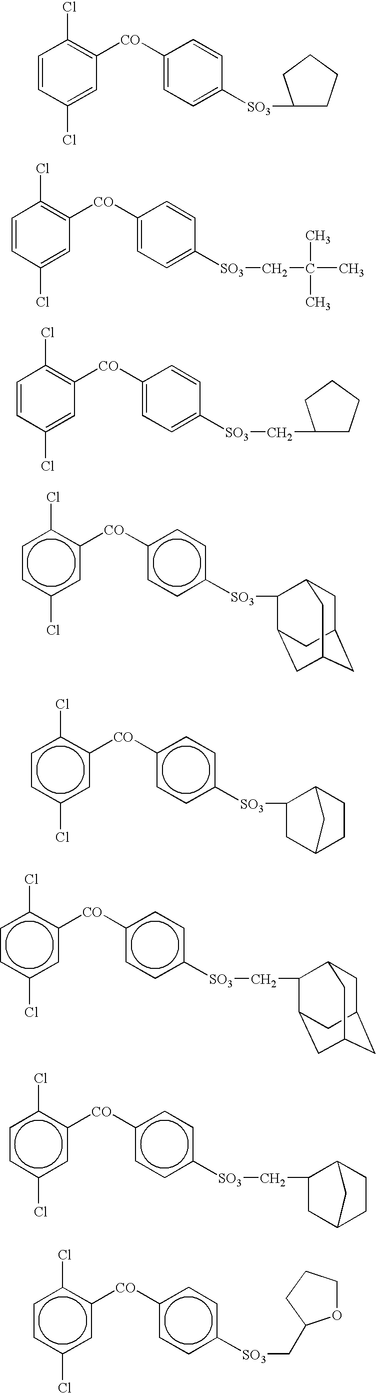

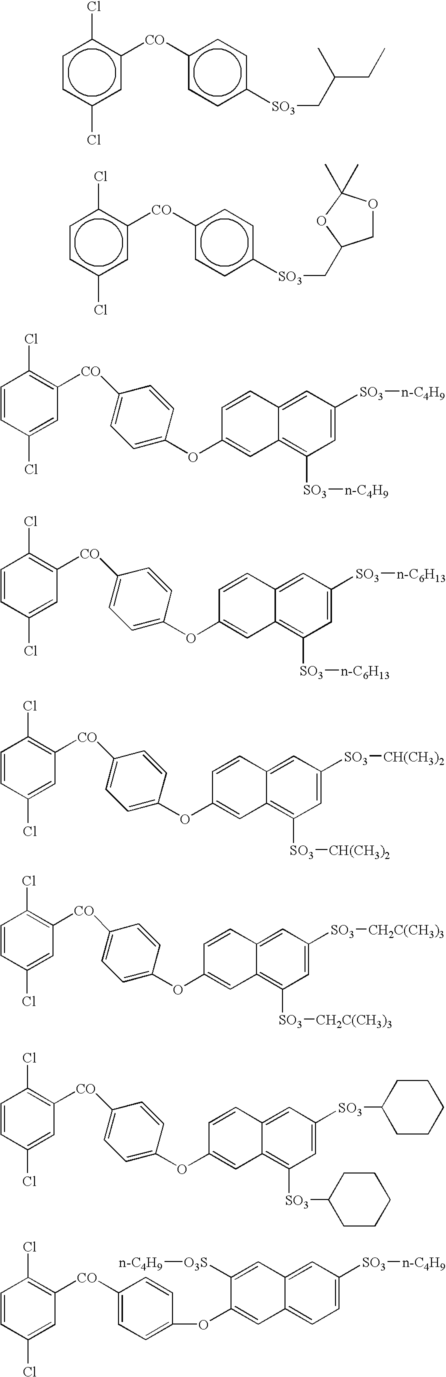

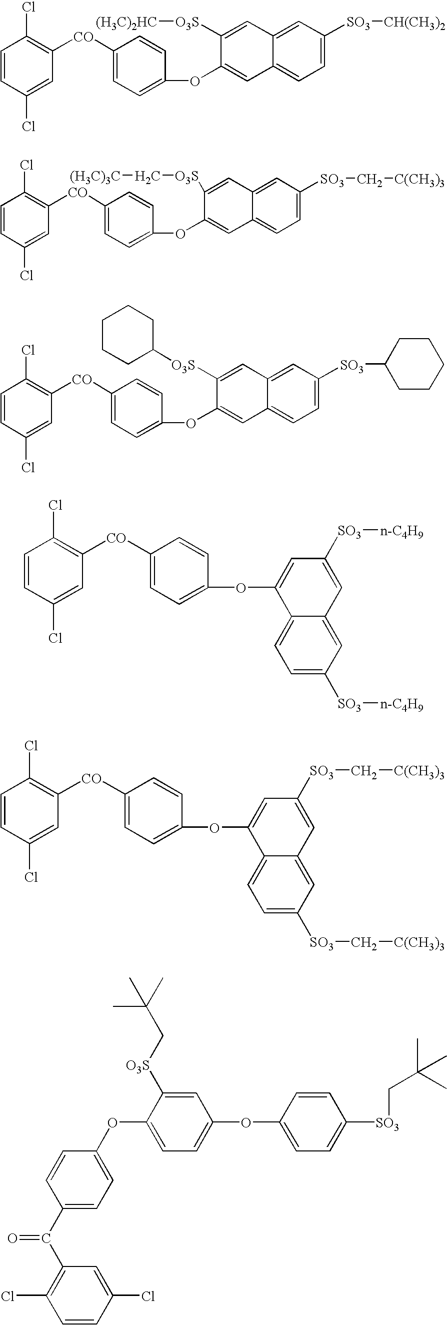

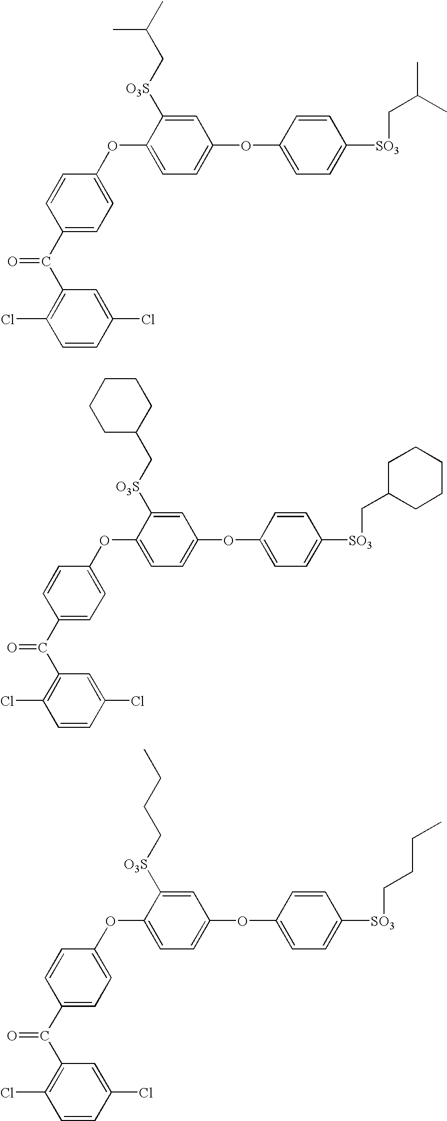

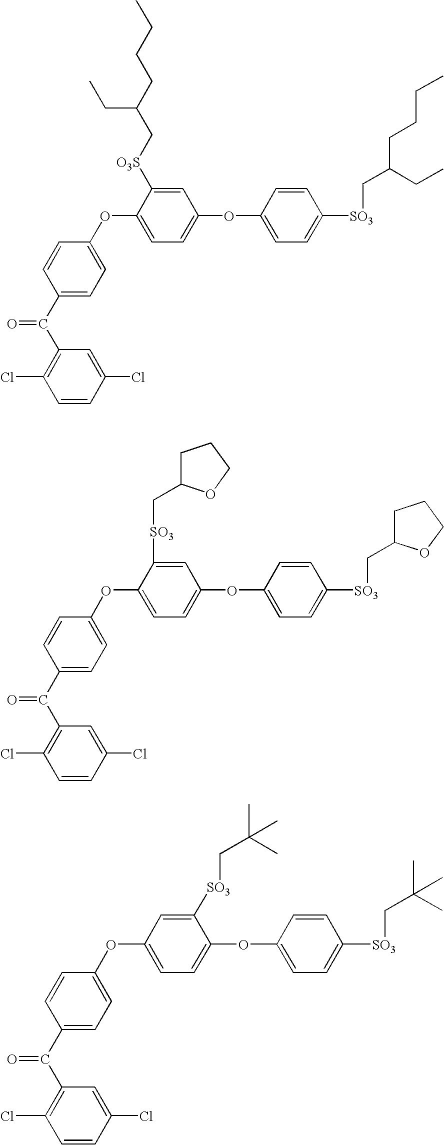

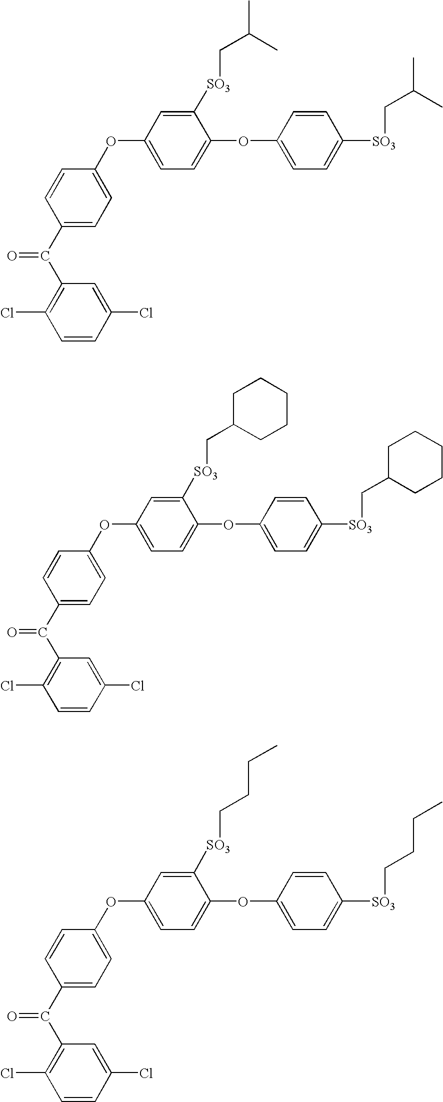

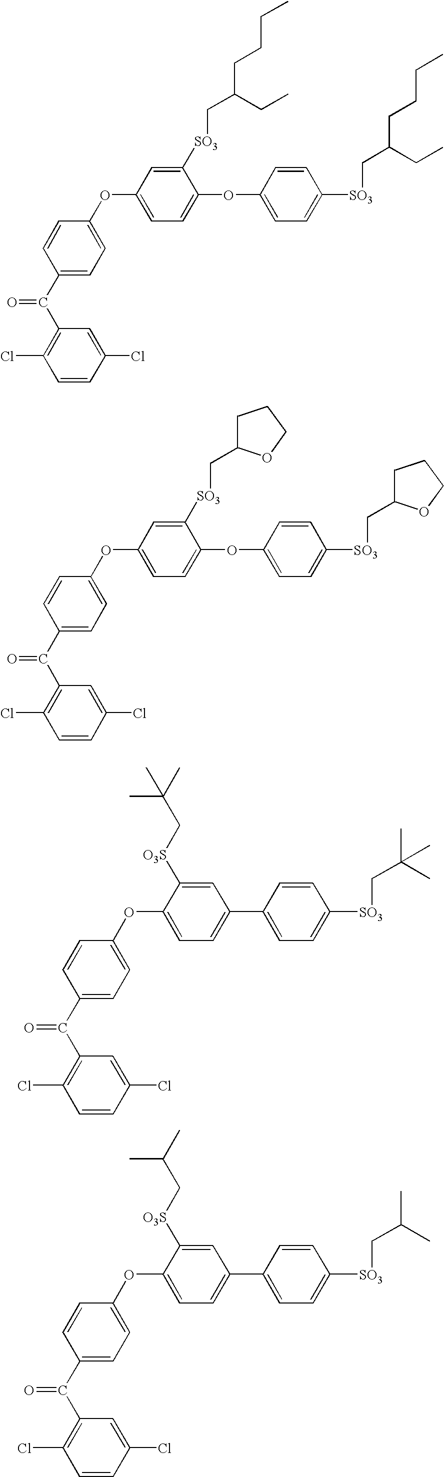

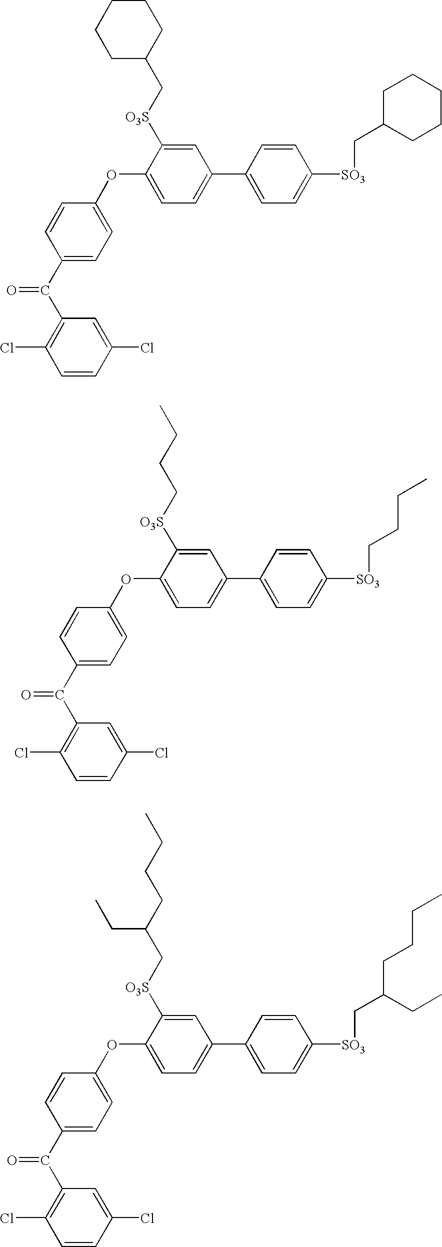

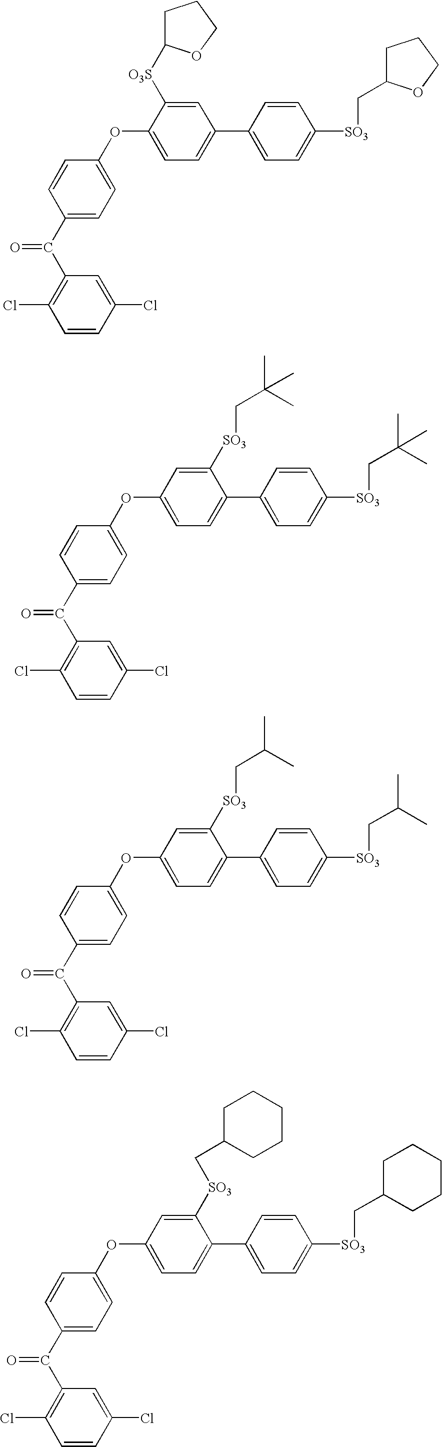

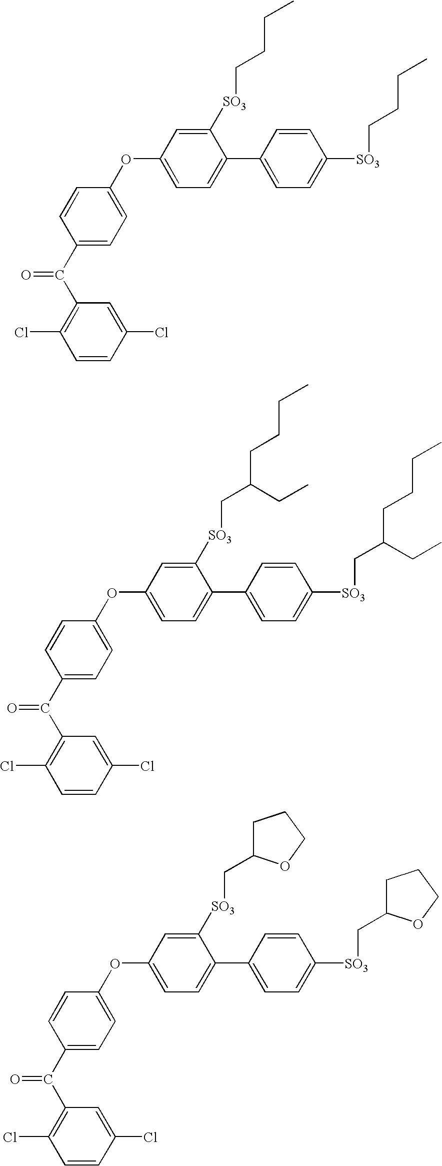

Also employable are aromatic sulfonate derivatives of the formula (D) that correspond to the above-illustrated compounds except that the chlorine atoms are replaced by bromine atoms, the —CO— group is replaced by the —SO₂— group, or these two replacements occur at the same time.

The R^{b} group in the formula (D) is preferably derived from a primary alcohol, and the βcarbon atom is preferably tertiary or quaternary. More preferably, such ester group is derived from a primary alcohol and the βcarbon atom is quaternary. When these two conditions are satisfied, excellent stability may be obtained during polymerization and no inhibited polymerization or crosslinking will result from the formation of sulfonic acids by deesterification.

The compounds represented by the formula (D) except having no sulfonic or sulfonate groups include the following compounds:

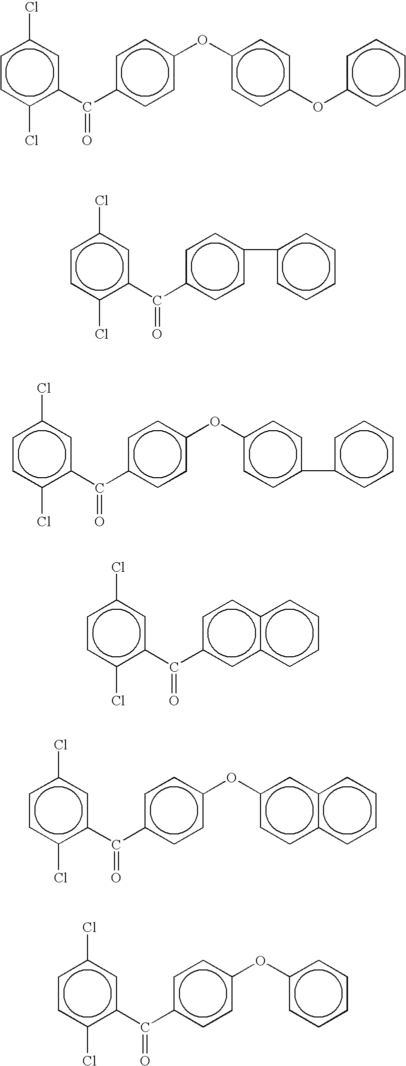

Also employable are compounds corresponding to the above compounds except that the chlorine atoms are replaced by bromine atoms, the —CO— group is replaced by the —SO₂— group, or these two replacements occur at the same time.

The oligomers capable of forming the structural unit of the formula (B) include oligomers represented by the following formula (E) (hereinafter, the oligomer(s) (E)):

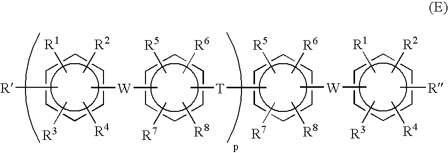

In the formula (E), R′ and R″ may be the same or different and are each a halogen atom other than fluorine or a —OSO₂G group (where G is an alkyl, fluorine-substituted alkyl or aryl group), and R¹ to R⁸, W, T and p are as described in the formula (B). Indicated by G, the alkyl groups include methyl and ethyl groups, the fluorine-substituted alkyl groups include trifluoromethyl group, and the aryl groups include phenyl and p-tolyl groups.

Exemplary compounds of the formula (E) in which p is 0 include 4,4′-dichlorobenzophenone, 4,4′-dichlorobenzanilide, bis(chlorophenyl)difluoromethane, 2,2-bis(4-chlorophenyl)hexafluoropropane, 4-chlorobenzoic acid-4-chlorophenyl, bis(4-chlorophenyl)sulfoxide, bis(4-chlorophenyl)sulfone, 2,6-dichlorobenzonitrile, 9,9-bis (4-hydroxyphenyl)fluorene, corresponding compounds to these compounds except that the chlorine atom is replaced with a bromine or an iodine atom, and corresponding compounds to the above compounds except that at least one of the halogen atoms substituted at the 4-position is altered to a substituent at the 3-position.

Exemplary compounds of the formula (E) in which p is 1 include 4,4′-bis(4-chlorobenzoyl)diphenyl ether, 4,4′-bis(4-chlorobenzoylamino)diphenyl ether, 4,4′-bis(4-chlorophenylsulfonyl)diphenyl ether, 4,4′-bis(4-chlorophenyl)diphenyl ether dicarboxylate, 4,4′-bis[(4-chlorophenyl)-1,1,1,3,3,3-hexafluoropropyl] diphenyl ether, 4,4′-bis[(4-chlorophenyl)tetrafluoroethyl]diphenyl ether, corresponding compounds to these compounds except that the chlorine atom is replaced with a bromine or an iodine atom, corresponding compounds to the above compounds except that the halogen substitution occurs at the 3-position in place of the 4-position, and corresponding compounds to the above compounds except that at least one of the substituent groups at the 4-position in the diphenyl ether is altered to a substituent at the 3-position.

The compounds of the formula (E) further include 2,2-bis[4-{4-(4-chlorobenzoyl)phenoxy}phenyl]-1,1,1,3,3,3-hexafluoropropane, bis[4-{4-(4-chlorobenzoyl) phenoxy}phenyl]sulfone, and compounds represented by the following formulae:

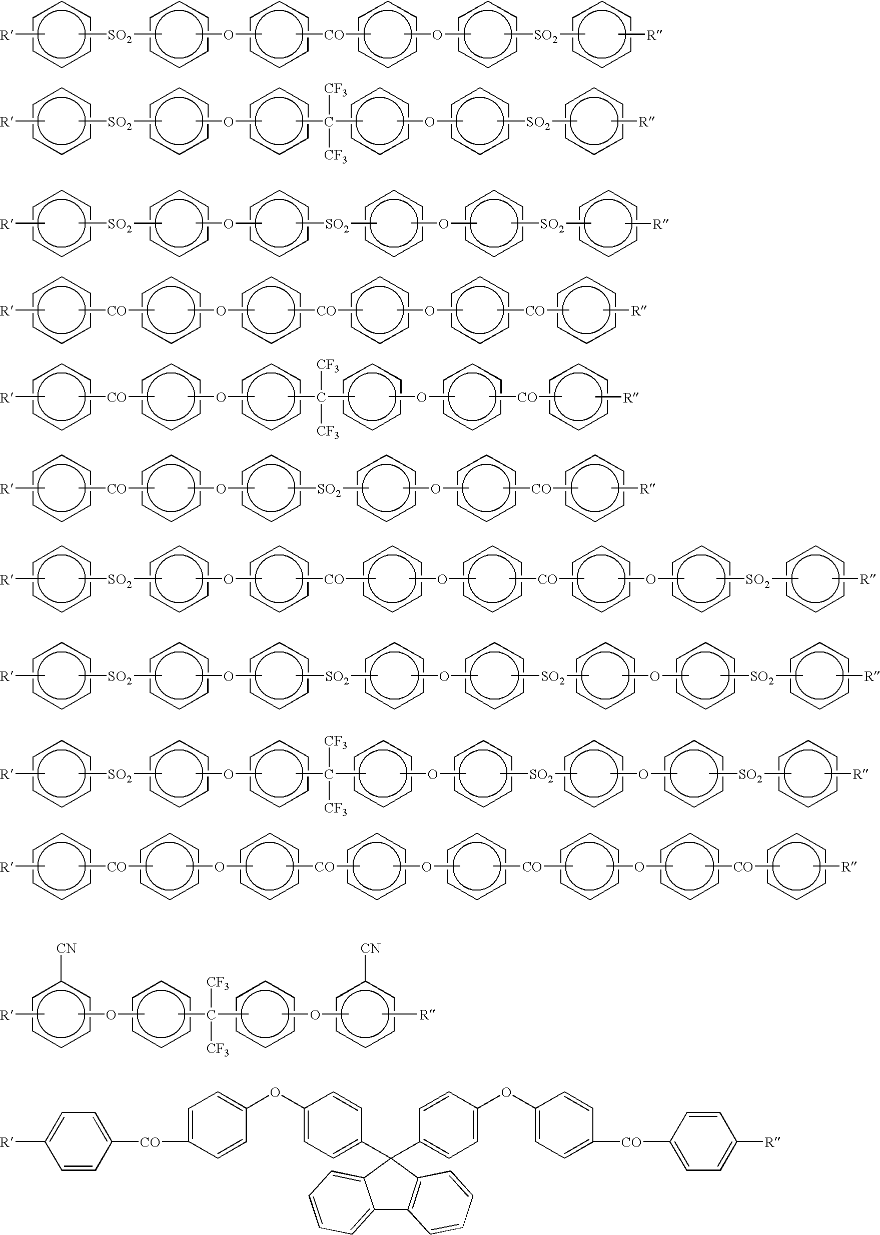

For example, the compounds represented by the formula (E) may be synthesized by the process given below.

First, an alkali metal such as lithium, sodium or potassium, or an alkali metal compound such as an alkali metal hydride, an alkali metal hydroxide or an alkali metal carbonate, is added to bisphenols combined together by the electron-withdrawing group thereby to convert them into a corresponding alkali metal salt of bisphenol. This reaction is made in a polar solvent of high dielectric constant, such as N-methyl-2-pyrrolidone, N,N-dimethylacetamide, sulfolane, diphenyl sulfone or dimethyl sulfoxide. The alkali metal will be generally used in slight excess over the hydroxyl groups of the bisphenol, for example 1.1 to 2 times, and preferably 1.2 to 1.5 times the equivalent weight of the hydroxyl groups.

Thereafter, the alkali metal salt of bisphenol is reacted with a halogen-substituted, e.g. fluorine- or chlorine-substituted, aromatic dihalide compound which has been activated by the electron-withdrawing groups, in the presence of a solvent that can form an azeotropic mixture with water, such as benzene, toluene, xylene, hexane, cyclohexane, octane, chlorobenzene, dioxane, tetrahydrofuran, anisole or phenetole. Examples of the above aromatic dihalide compound include 4,4′-difluorobenzophenone, 4,4′-dichlorobenzophenone, 4,4′-chlorofluorobenzophenone, bis(4-chlorophenyl)sulfone, bis(4-fluorophenyl)sulfone, 4-fluorophenyl-4′-chlorophenylsulfone, bis(3-nitro-4-chlorophenyl)sulfone, 2,6-dichlorobenzonitrile, 2,6-difluorobenzonitrile, hexafluorobenzene, decafluorobiphenyl, 2,5-difluorobenzophenone and 1,3-bis(4-chlorobenzoyl)benzene. From the viewpoint of reactivity, the aromatic dihalide compound is desirably a fluorine compound. But taking the subsequent aromatic coupling reaction into account, the aromatic nucleophilic substitution reaction should be designed to take place so as to yield a molecule having a chlorine atom at its end(s).

The active aromatic dihalide compound may be used in an amount 2 to 4 times, and preferably 2.2 to 2.8 times the moles of the bisphenol. The reaction temperature is in the range of 60 to 300° C., and preferably 80 to 250° C. The reaction time ranges from 15 minutes to 100 hours, and preferably from 1 to 24 hours.

Optimally, the active aromatic dihalide compound is a chlorofluoro compound as shown in the formula below that has two halogen atoms different in reactivity from each other. The use of this compound is advantageous in that the fluorine atom will preferentially undergo the nucleophilic substitution reaction with phenoxide so that the objective chlorine-terminated active compound may be obtained. 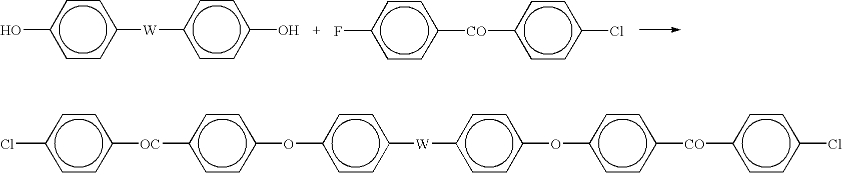
wherein W is as defined in the formula (E).

Alternatively, the nucleophilic substitution reaction may be carried out in combination with electrophilic substitution reaction to synthesize an objective flexible compound comprising the electron-withdrawing and electron-donating groups, as described in JP-A-H02-159.

Specifically, the aromatic bis-halide activated by the electron-withdrawing groups, such as bis(4-chlorophenyl)sulfone, is subjected to the nucleophilic substitution reaction with a phenol; thereafter the resultant bis-phenoxy compound is subjected to Friedel-Crafts reaction with, for example, 4-chlorobenzoyl chloride to give an objective compound.

The aromatic bis-halide activated by the electron-withdrawing groups used herein may be selected from the above-exemplified aromatic dihalide compounds. The phenol compound may be substituted, but is preferably unsubstituted from the viewpoints of heat resistance and flexibility. When substituted, the substituted phenol compound is preferably an alkali metal salt. Any of the alkali metal compounds listed above can be used in the substitution reaction for the phenol compound. The alkali metal compound may be used in an amount 1.2 to 2 times the mole of the phenol. In the reaction, the aforesaid polar solvent or the azeotropic solvent with water may be employed.

The chlorobenzoyl chloride is used in an amount 2 to 4 times, and preferably 2.2 to 3 times the moles of the bis-phenoxy compound. The Friedel-Crafts reaction between the bis-phenoxy compound and the acylating agent chlorobenzoyl chloride is preferably carried out in the presence of an activator for the Friedel-Crafts reaction, such as aluminum chloride, boron trifluoride or zinc chloride. The Friedel-Crafts reaction activator is used in an amount 1.1 to 2 times the moles of the active halide compound such as the acylating agent chlorobenzoic acid. The reaction time is in the range of 15 minutes to 10 hours, and the reaction temperature is in the range of −20 to 80° C. As a solvent, chlorobenzene, nitrobenzene or the like that is inactive in the Friedel-crafts reaction may be used.

The compound of the formula (E) in which p is 2 or greater may be synthesized by polymerization in accordance with the above-mentioned procedure. In this case, a bisphenol, which can supply ether oxygen as the electron-donating group T in the formula (E), is combined with one or more electron-withdrawing groups W selected from >C═O, —SO₂— and >C(CF₃)₂ to give a bisphenol compound such as 2,2-bis(4-hydroxyphenyl)-1,1,1,3,3,3-hexafluoropropane, 2,2-bis(4-hydroxyphenyl)ketone or 2,2-bis(4-hydroxyphenyl) sulfone. The compound is then converted into an alkali metal salt of bisphenol and is subjected to substitution reaction with an excess of the activated aromatic halide such as 4,4-dichlorobenzophenone or bis(4-chlorophenyl)sulfone, in the presence of a polar solvent such as N-methyl-2-pyrrolidone, N,N-dimethylacetamide or sulfolane.

Examples of such compounds include those represented by the following formulae:

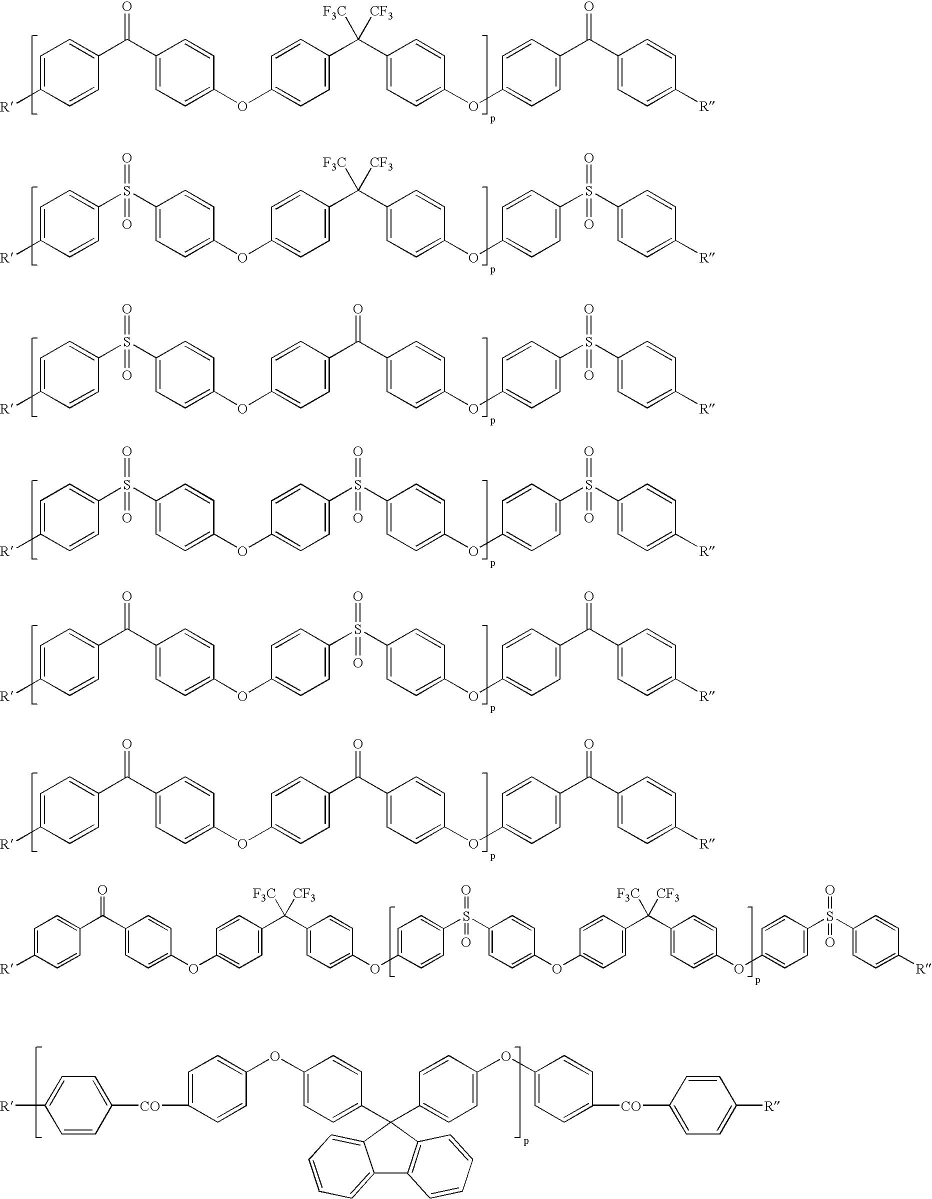

To synthesize the polyarylene having a sulfonate group, the monomer (D) and the oligomer (E) are reacted in the presence of a catalyst. The catalyst used herein is a catalyst system containing a transition metal compound. This catalyst system essentially contains (1) a transition metal salt and a compound which functions as a ligand (referred to as the “ligand component” hereinafter), or a transition metal complex (including a copper salt) to which ligands are coordinated, and (2) a reducing agent. A “salt” may be added to increase the polymerization rate.

Examples of the transition metal salt include nickel compounds such as nickel chloride, nickel bromide, nickel iodide and nickel acetylacetonate; palladium compounds such as palladium chloride, palladium bromide and palladium iodide; iron compounds such as iron chloride, iron bromide and iron iodide; and cobalt compounds such as cobalt chloride, cobalt bromide and cobalt iodide. Of these, nickel chloride and nickel bromide are particularly preferred.

Examples of the ligand component include triphenylphosphine, 2,2′-bipyridine, 1,5-cyclooctadiene and 1,3-bis(diphenylphosphino)propane. Of these, triphenylphosphine and 2,2′-bipyridine are preferred. The ligand components may be used either singly or in combination of two or more kinds.

Examples of the transition metal complex with coordinated ligands include nickel chloride-bis(triphenylphosphine), nickel bromide-bis(triphenylphosphine), nickel iodide-bis(triphenylphosphine), nickel nitrate-bis(triphenylphosphine), nickel chloride(2,2′-bipyridine), nickel bromide(2,2′-bipyridine), nickel iodide(2,2′-bipyridine), nickel nitrate(2,2′-bipyridine), bis(1,5-cyclooctadiene)nickel, tetrakis(triphenylphosphine)nickel, tetrakis(triphenylphosphito)nickel and tetrakis(triphenylphosphine)palladium. Of these, nickel chloride-bis(triphenylphosphine) and nickel chloride(2,2′-bipyridine) are preferred.

Examples of the reducing agent employable in the aforesaid catalyst system include iron, zinc, manganese, aluminum, magnesium, sodium and calcium. Of these, zinc, magnesium and manganese are preferable. These reducing agents may be used in a more activated form by being contacted with an acid such as an organic acid.

Examples of the “salt” employable in the catalyst system include sodium compounds such as sodium fluoride, sodium chloride, sodium bromide, sodium iodide and sodium sulfate; potassium compounds such as potassium fluoride, potassium chloride, potassium bromide, potassium iodide and potassium sulfate; and ammonium compounds such as tetraethylammonium fluoride, tetraethylammonium chloride, tetraethylammonium bromide, tetraethylammonium iodide and tetraethylammonium sulfate. Of these, sodium bromide, sodium iodide, potassium bromide, tetraethylammonium bromide and tetraethylammonium iodide are preferred.

In respect of the proportion of the above components, the transition metal salt or the transition metal complex is usually used in an amount of 0.0001 to 10 mol, and preferably 0.01 to 0.5 mol per mol of the monomers combined ((D)+(E), the same applies hereinafter). If the amount is less than 0.0001 mol, the polymerization may not proceed sufficiently. Contrary, the amount exceeding 10 mol may result in a lowered molecular weight of the polyarylene.

When the catalyst system contains the transition metal salt and the ligand component, the ligand component usually has an amount of 0.1 to 100 mol, and preferably 1 to 10 mol per mol of the transition metal salt. If the amount is less than 0.1 mol, the catalytic activity may become insufficient. Contrary, the amount exceeding 100 mol may result in a lowered molecular weight of the polyarylene.

The amount of the reducing agent is usually in the range of 0.1 to 100 mol, and preferably 1 to 10 mol per mol of the monomers combined. If the reducing agent is used in an amount less than 0.1 mol, the polymerization may not proceed sufficiently. Contrary, the amount thereof exceeding 100 mol may lead to difficult purification of the resulting polymer.

When the “salt” is used, the amount thereof is usually 0.001 to 100 mol, and preferably 0.01 to 1 mol per mol of the monomers combined. If the salt is used in an amount less than 0.001 mol, an effect of increasing the polymerization rate is often insufficient. Contrary, the amount thereof exceeding 100 mol may result in difficult purification of the polymer obtained.

Suitable polymerization solvents for use in the reaction between the monomer (D) and the oligomer (E) include tetrahydrofuran, cyclohexanone, dimethyl sulfoxide, N,N-dimethylformamide, N,N-dimethylacetamide, N-methyl-2-pyrrolidone, γ-butyrolactone and N,N′-dimethylimidazolidinone. Of these, tetrahydrofuran, N,N-dimethylformamide, N,N-dimethylacetamide, N-methyl-2-pyrrolidone and N,N′-dimethylimidazolidinone are preferred. These polymerization solvents are desirably used after dried sufficiently.

The concentration of all the monomers combined in the polymerization solvent is usually in the range of 1 to 90 wt %, and preferably 5 to 40 wt %.

The polymerization temperature is generally in the range of 0 to 200° C., and preferably 50 to 120° C., and the polymerization time generally ranges from 0.5 to 100 hours, and preferably from 1 to 40 hours.

The polyarylene having a sulfonate group derived from the monomer (D) will be subjected to hydrolysis to convert the sulfonate group into the sulfonic group, thereby obtaining the polyarylene having a sulfonic group.

For example, the hydrolysis may be performed by any of the following methods:

(1) The polyarylene with a sulfonate group is added to an excess of water or an alcohol that contains a little hydrochloric acid, and the mixture is stirred for at least 5 minutes.

(2) The polyarylene with a sulfonate group is reacted in trifluoroacetic acid at about 80 to 120° C. for about 5 to 10 hours.

(3) The polyarylene with a sulfonate group is reacted in a solution such as N-methylpyrrolidone that contains lithium bromide in an amount 1 to 3 times the moles of the sulfonate groups (—SO₃R) of the polyarylene, at about 80 to 150° C. for about 3 to 10 hours, and thereafter hydrochloric acid is added to the reaction product.

Alternatively, the polyarylene having a sulfonic group may be obtained by copolymerizing a monomer of the formula (D) except having no sulfonate groups with the oligomer (E) of the formula (E), and sulfonating the thus-synthesized polyarylene copolymer. Specifically, a polyarylene having no sulfonic group is produced by the above-described procedure and treated with a sulfonating agent to introduce a sulfonic group in the polyarylene. The polyarylene having a sulfonic group may be thus obtained.

The sulfonation may be performed by treating the polyarylene having no sulfonic group with a conventional sulfonating agent, such as sulfuric anhydride, fuming sulfuric acid, chlorosulfonic acid, sulfuric acid or sodium bisulfite, in the absence or presence of a solvent according under known conditions. (See Polymer Preprints, Japan, vol. 42, No. 3, p. 730 (1993), Polymer Preprints, Japan, vol. 43, No. 3, p. 736 (1994), and Polymer Preprints, Japan, vol. 42, No. 7, pp. 2490-2492 (1993).)

The solvents used herein include hydrocarbon solvents such as n-hexane; ether solvents such as tetrahydrofuran and dioxane; aprotic polar solvents such as dimethylacetamide, dimethylformamide and dimethyl sulfoxide; and halogenated hydrocarbons such as tetrachloroethane, dichloroethane, chloroform and methylene chloride. The reaction temperature is not particularly limited, but is usually in the range of −50 to 200° C., and preferably −10 to 100° C. The reaction time is usually 0.5 to 1,000 hours, and preferably 1 to 200 hours.

The thus-produced polyarylene having a sulfonic group will generally contain the sulfonic groups in an amount of 0.3 to 5 meq/g, preferably 0.5 to 3 meq/g, and more preferably 0.8 to 2.8 meq/g. If the sulfonic group content is less than 0.3 meq/g, the proton conductance will not reach a practical level. Contrary, when it exceeds 5 meq/g, water resistance will be drastically deteriorated.

The sulfonic group content may be manipulated by changing the types, amounts and combination of the monomer (D) and the oligomer (E).

The polyarylene having a sulfonic group has a weight-average molecular weight of 10,000 to 1,000,000, and preferably 20,000 to 800,000, as measured by gel permeation chromatography (GPC) in terms of polystyrene.

The polyarylene having a sulfonic group may contain an anti-aging agent, preferably a hindered phenol compound with a molecular weight of not less than 500. Such anti-aging agents provide longer durability of the electrolyte.

The hindered phenol compounds employable in the invention include triethyleneglycol-bis[3-(3-t-butyl-5-methyl-4-hydroxyphenyl)propionate] (trade name: IRGANOX 245), 1,6-hexanediol-bis[3-(3,5-di-t-butyl-4-hydroxyphenyl) propionate] (trade name: IRGANOX 259), 2,4-bis-(n-octylthio)-6-(4-hydroxy-3,5-di-t-butylanilino)-3,5-triadine (trade name: IRGANOX 565), pentaerythrithyl-tetrakis[3-(3,5-di-t-butyl-4-hydroxyphenyl)propionate] (trade name: IRGANOX 1010), 2,2-thio-diethylene-bis[3-(3,5-di-t-butyl-4-hydroxyphenyl)propionate] (trade name: IRGANOX 1035), octadecyl-3-(3,5-di-t-butyl-4-hydroxyphenyl)propionate (trade name: IRGANOX 1076), N,N-hexamethylenebis (3,5-di-t-butyl-4-hydroxy-hydrocinnamide) (trade name: IRGANOX 1098), 1,3,5-trimethyl-2,4,6-tris(3,5-di-t-butyl-4-hydroxybenzyl)benzene (trade name: IRGANOX 1330), tris-(3,5-di-t-butyl-4-hydroxybenzyl)-isocyanurate (trade name: IRGANOX 3114) and 3,9-bis[2-[3-(3-t-butyl-4-hydroxy-5-methylphenyl)propionyloxy]-1,1-dimethylethyl]-2,4,8,10-tetraoxaspiro[5.5]undecane (trade name: Sumilizer GA-80).

The hindered phenol compound will preferably be used in an amount of 0.01 to 10 parts by weight per 100 parts by weight of the polyarylene having a sulfonic group.

(Proton Conductive Composition)

The proton conductive compositions of the invention contain the aforesaid nonconductive filler and polyarylene having a sulfonic group. The compositions may further contain inorganic acids such as sulfuric and phosphoric acids, organic acids including carboxylic acids, an appropriate amount of water, and the like.

The proton conductive compositions desirably contain the nonconductive filler particles in amounts of 3 to 50% by volume, preferably 5 to 40% by volume, and more preferably 10 to 30% by volume relative to the composition (100% by volume) When the content of the filler particles is less than the above range, prevention of a short circuit between the electrodes may not be ensured. If the content exceeds the above range, the proton nonconductive component is so increased that the proton conductance is lowered, and mechanical characteristics also tend to deteriorate.

The proton conductive compositions of the invention may be prepared by mixing the aforesaid components in a predetermined ratio by means of a conventional high-shear mixer, such as a homogenizer, a disperser, a paint conditioner (a paint mixing and conditioning machine) or a ball mill. A solvent may be optionally used in the mixing.

(Proton Conductive Membrane)

The proton conductive membranes of the invention comprise any of the aforesaid proton conductive compositions. In addition to the nonconductive filler particles and the polyarylene having a sulfonic group, the proton conductive membranes may further contain inorganic acids such as sulfuric and phosphoric acids, organic acids including carboxylic acids, an appropriate amount of water, and the like.

For example, the proton conductive membrane may be produced by a casting method in which the proton conductive composition is cast over a substrate to form a film.

The substrate used herein may be a polyethyleneterephthalate (PET) film, but is not particularly limited thereto. Any substrates commonly used in the solution casting methods may be employed. Examples include plastic substrates and metal substrates.

Although the concentration of the polyarylene having a sulfonic group in the solution (i.e. the polymer concentration) depends on the molecular weight of the polyarylene, it is generally from 5 to 40 wt %, and preferably from 7 to 25 wt %. The polymer concentration less than 5 wt % causes difficulties in producing the membrane in large thickness and results in easy occurrence of pinholes. On the other hand, when the polymer concentration goes over 40 wt %, the solution viscosity becomes so high that the film production will be difficult and further that the obtained membrane often has low surface smoothness.

The viscosity of the solution containing the composition of the invention may vary depending on the molecular weight of the polyarylene or the solid concentration. Generally, the solution viscosity ranges from 2,000 to 100,000 mPa·s, and preferably from 3,000 to 50,000 mPa·s. When the viscosity is less than 2,000 mPa·s, the solution will have too high a fluidity and may spill out of the substrate during the membrane production. On the contrary, the viscosity over 100,000 mPa·s is so high that the solution cannot be extruded through a die and the film-casting becomes difficult.

The coating formed by the casting method is dried at 30 to 160° C., preferably 50 to 150° C., for a period of 3 to 180 minutes, preferably 5 to 120 minutes to give a film (proton conductive membrane). The thickness of the proton conductive membrane is desirably such that the diameters of the nonconductive filler particles range from 3 to 90%, and preferably 20 to 70% the thickness of the proton conductive membrane. Specifically, the membrane thickness is desirably 100 μm or less, preferably from 3 to 50 μm, and more preferably from 5 to 20 μm.

The solvent for use in the casting method is not particularly limited. Exemplary solvents include aprotic polar solvents such as γ-butyrolactone, dimethylacetamide, dimethylformamide, N-methyl-2-pyrrolidone, dimethylsulfoxide and dimethylurea. These solvents may be used in combination with alcohol solvents such as methanol, ethanol, n-propyl alcohol, iso-propyl alcohol and 1-methoxy-2-propanol.

The proton conductive membrane may be a composite membrane which consists of a proton conductive membrane containing the filler particles and a proton conductive membrane free from such filler particles (two-layer membrane), or which consists of two proton conductive membranes containing no filler particles and, interposed therebetween, a proton conductive membrane containing the filler particles (three-layer membrane).

To produce such composite membranes, a proton conductive membrane containing the filler particles and a proton conductive membrane free from the filler particles may be separately prepared and bonded together by hot pressing or the like. Alternatively, a proton conductive membrane containing the filler particles may be formed on a proton conductive membrane free from the filler particles by printing, coating or spraying technique. The composite membrane may be also manufactured by directly joining such membranes by means of a hot press.

In the proton conductive membranes obtained as described above, the filler particles are dispersed substantially uniformly throughout the membrane. The present invention, however, does not necessarily require uniform dispersion of the filler particles throughout the membrane, and the filler particles may be present so as to form a layer extending perpendicularly to the membrane thickness.

The proton conductive membranes desirably contain the nonconductive filler particles in amounts of 3 to 50% by volume, preferably 5 to 40% by volume, and more preferably 10 to 30% by volume relative to the membrane (100% by volume). When the content of the filler particles is less than the above range, a short circuit between the electrodes may not be prevented. If the content exceeds the above range, the proton nonconductive component is so increased that the proton conductance is lowered, and mechanical characteristics also tend to deteriorate.

The proton conductive compositions and cast membranes from the compositions can be suitably used as electrolytes for primary and secondary batteries, proton conductive membranes for display elements, sensors, signaling media and solid condensers, and ion exchange membranes.

### EXAMPLES

The present invention will be hereinafter described in greater detail by Examples presented below, but it should be construed that the invention is in no way limited to those Examples.

In Examples, the sulfonic acid equivalent and the molecular weight were measured, and the fuel cell performance was evaluated as described below.

1. Sulfonic Acid Equivalent

The polymer having a sulfonic group was washed until the washings became neutral, and free residual acids were removed. The polymer was then sufficiently washed with water and dried. A predetermined amount of the polymer was weighed out and dissolved in a THF/water mixed solvent. The resultant solution was mixed with phenolphthalein as an indicator and then titrated with an NaOH standard solution to obtain a point of neutralization, from which the sulfonic acid equivalent was determined.

2. Measurement of Molecular Weight

The polyarylene having no sulfonic group was analyzed by GPC using a tetrahydrofuran (THF) solvent to measure the molecular weight in terms of polystyrene. The polyarylene having a sulfonic group was analyzed by GPC using a solvent (eluting solution) consisted of N-methyl-2-pyrrolidone (NMP) mixed with lithium bromide and phosphoric acid, to measure the molecular weight in terms of polystyrene.

3. Manufacturing and Performance Evaluation of Fuel Cell

The solid electrolyte membrane obtained was sandwiched between two electrodes (supporting 0.5 mg/cm² of platinum), and they were hot pressed at 80° C. and 5 Mpa for 2 minutes (primary hot pressing) and then at 160° C. and 4 MPa for 1 minute (secondary hot pressing) to give a membrane-electrode assembly. The membrane-electrode assembly was then sandwiched between two titanium collectors, and a heater was arranged outside the collector. Thus, a fuel cell having an effective area of 25 cm² was manufactured.

With the fuel cell temperature maintained at 85° C., hydrogen and air were supplied at 90% RH or above, and a generating endurance test was conducted at a current density of 1.0 A/cm².

### Synthesis Example 1

Preparation of Oligomer

A 1-L three-necked flask equipped with a stirrer, a thermometer, a cooling tube, a Dean-Stark tube and a three-way nitrogen inlet cock, was charged with 67.3 g (0.20 mol) of 2,2-bis(4-hydroxyphenyl)-1,1,1,3,3,3-hexafluoropropane (bisphenol AF), 60.3 g (0.24 mol) of 4,4′-dichlorobenzophenone (4,4′-DCBP), 71.9 g (0.52 mol) of potassium carbonate, 300 ml of N,N-dimethylacetamide (DMAc) and 150 ml of toluene. With the flask in an oil bath, the contents were reacted by being stirred in a nitrogen atmosphere at 130° C. Reaction was carried out while the water resulting from the reaction was removed as an azeotropic mixture with toluene, outside the system through the Dean-Stark tube. Water almost ceased to occur in about 3 hours, and most of the toluene was removed while gradually raising the reaction temperature from 130° C. to 150° C. After reaction had been made at 150° C. for 10 hours, 10.0 g (0.040 mol) of 4,4′-DCBP was added to carry out reaction for another 5 hours. Subsequently, the reaction liquid was cooled naturally and was filtered to remove precipitated by-product inorganic compounds. The filtrate was poured into 4 L of methanol to precipitate the product. The precipitated product was filtered off, recovered, dried and dissolved in 300 mL of tetrahydrofuran. The resultant solution was poured into 4 L of methanol to perform reprecipitation. Thus, 95 g of a desired compound was obtained (85% yield).

GPC (THF solvent) provided that the compound had a number-average molecular weight (Mn) of 11,200 in terms of polystyrene. The polymer compound was found to be soluble in THF, NMP, DMAc and sulfolane, and to have Tg (glass transition temperature) of 110° C. and a thermal decomposition temperature of 498° C. The compound was an oligomer having the formula (I) (hereinafter, the BCPAF oligomer):

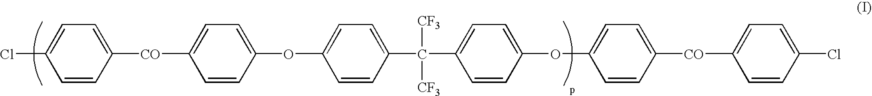

### Synthesis Example 2

Preparation of Polyarylene Copolymer Having Sulfonic Group

A 1-L three-necked flask equipped with a stirrer, a thermometer, a cooling tube, a Dean-Stark tube and a three-way nitrogen inlet cock, was charged, in a nitrogen atmosphere, with 39.58 g (98.64 mmol) of neo-pentyl 4-[4-(2,5-dichlorobenzoyl)phenoxy]benzenesulfonate (A-SO₃ neo-Pe), 15.23 g (1.36 mmol) of the BCPAF oligomer obtained in Synthesis Example 1, 1.67 g (2.55 mmol) of Ni(PPh₃)₂Cl₂, 10.49 g (40 mmol) of PPh₃, 0.45 g (3 mmol) of NaI, 15.69 g (240 mmol) of zinc powder and 390 ml of dry NMP. Reaction was carried out by heating the system (finally to 75° C.) with stirring for 3 hours. The polymerization solution was diluted with 250 ml of THF, stirred for 30 minutes, and filtered with use of Celite as filter aid. The filtrate was poured into large excess (1500 ml) of methanol to precipitate the product. The precipitated product was filtered off, air dried, then redissolved in THF/NMP (200/300 ml) and precipitated in large excess (1500 ml) of methanol. The precipitated product was air dried and then heat dried to give 47.0 g (99% yield) of an objective yellow fibrous copolymer including a neopentyl-protected sulfonic acid derivative (Poly AB-SO₃neo-Pe). GPC provided a Mn of 47,600 and weight-average molecular weight (Mw) of 159,000.

5.1 Grams of Poly AB-SO₃neo-Pe was dissolved in 60 ml of NMP, and the resultant solution was heated to 90° C. To the reaction system, a mixture consisting of 50 ml of methanol and 8 ml of concentrated hydrochloric acid was added all at once. Reaction was carried out under mild reflux conditions for 10 hours while maintaining the dispersion state. Excess methanol was distilled away using a distillation apparatus equipped, leaving a light green transparent solution. The solution was then poured into an excess of water/methanol (1:1 by weight) to precipitate the polymer. Subsequently, the polymer was washed with ion exchange water until pH of the washings became at least 6. Polymer's IR spectrum and quantitative analysis for ion exchange capacity provided that the sulfonate groups (—SO₃R^{a}) had been quantitatively converted to the sulfonic groups (—SO₃H).

GPC for the polyarylene copolymer having a sulfonic group gave Mn of 53,200 and Mw of 185,000. The sulfonic acid equivalent was 1.9 meq/g.

### Example 1

The polyarylene with a sulfonic group obtained in Synthetic Example 2 was formed into a film. This film and 5 μm diameter titania particles were placed in a plastic bottle in a volume ratio of 80:20 (% by volume) (film:particles), followed by addition of γ-butyrolactone. The mixture was stirred with a disperser for 20 minutes to give a uniform dispersion.

The dispersion was cast over a PET film by a bar coater method, and the resultant coating was dried at 80° C. for 30 minutes and then at 140° C. for 60 minutes to give a solid electrolyte film 1 containing 20% by volume titania particles and having a thickness of 20 μm.

A membrane-electrode assembly including the solid electrolyte film 1 was subjected to the generating endurance test. The test proved that the assembly was capable of generating continuously for at least 1000 hours. Lowering in the terminal voltage after 1000 hours from initiation of the generation was not more than 5%.

### Comparative Example 1

60 Grams of the polyarylene with a sulfonic group obtained in Synthetic Example 2 was placed in a 1000 cc plastic bottle, and was dissolved by addition of 340 g of γ-butyrolactone.

The solution was cast over a PET film by a bar coater method, and the resultant coating was dried at 80° C. for 30 minutes and then at 140° C. for 60 minutes to give a solid electrolyte film 2 having a uniform thickness of 20 μm.

A membrane-electrode assembly including the solid electrolyte film 2 was subjected to the generating endurance test. The test resulted in drastic lowering in terminal voltage after the lapse of about 800 hours. Inspection of the membrane-electrode assembly confirmed that the electrodes had penetrated the membrane and been short-circuited.

[Comparative Example 2]

A film was prepared from a 20.6 wt % solution of Nafion (trade name, available from DuPont) in a water-alcohol solvent (water:alcohol (weight ratio)=20:60). This film and 5 μm diameter titania particles were placed in a plastic bottle in a volume ratio of 80:20 (% by volume) (film:particles), followed by addition of ethanol. The mixture was stirred with a disperser for 20 minutes to give a uniform dispersion. The alcohol in the water-alcohol solution of Nafion consisted of ethanol and n-propyl alcohol.

The dispersion was cast over a PET film by a bar coater method, and the resultant coating was dried at 80° C. for 60 minutes to give a solid electrolyte film 3 containing 20% by volume titania particles and having a thickness of 20 μm.

A membrane-electrode assembly including the solid electrolyte film 3 was subjected to the generating endurance test. The test resulted in drastic lowering in terminal voltage after the lapse of about 300 hours. Inspection of the membrane-electrode assembly confirmed that the electrodes had penetrated the membrane and been short-circuited.

1. A proton conductive composition comprising nonconductive filler particles and a polyarylene having a sulfonic group.

2. The proton conductive composition according to claim 1, wherein the polyarylene having a sulfonic group includes a structural unit represented by the following formula (A) and a structural unit represented by the following formula (B): 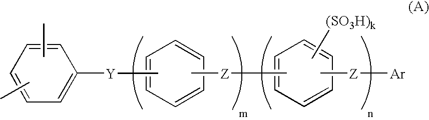
wherein Y is a divalent electron-withdrawing group; Z is a divalent electron-donating group or a direct bond; Ar is an aromatic group with a substituent —SO₃H; m is an integer of 0 to 10; n is an integer of 0 to 10; and k is an integer of 1 to 4; 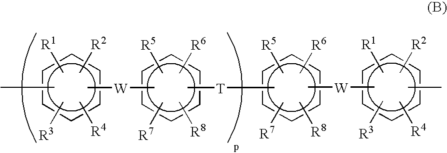
wherein R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group; W is a divalent electron-withdrawing group or a single bond; T is a divalent organic group or a single bond; and p is 0 or a positive integer.

3. A proton conductive membrane comprising the proton conductive composition of claim (1) or (2).

4. The proton conductive membrane according to claim 3, wherein the nonconductive filler particles are contained in an amount of 3 to 50% by volume of the proton conductive membrane and have particle diameters ranging from 3 to 90% the thickness of the proton conductive membrane.
